(19) United States
(12) Patent Application Publication
(10) Pub. No.: US 2007/0098831 A1
(43) Pub. Date: May 3, 2007

(54) MOLD FOR INJECTION MOLDING

(76) Inventor: Tae Shik Yoon, Seoul (KR)

Correspondence Address: SHERR & NOURSE, PLLC, 620 HERNDON PARKWAY, SUITE 200, HERNDON, VA, 20170, US

(21) Appl. No.: 11/530,049

(22) Filed: Sep. 8, 2006

(30) Foreign Application Priority Data
Sep. 9, 2005 (KR) 2005-84136

(51) Int. Cl. B29C 45/26

(52) U.S. Cl. 425/190; 425/542

(57) ABSTRACT

According to the present invention, there is provided with a mold for injection molding comprising a first mold having a concave first molding surface; and a second mold having a convex second molding surface, the second mold being arranged to be spaced from the first mold for a cavity to be defined between the first and second molding surfaces. At this time, the second mold includes a plurality of unit molds coupled with and disassembled from each other, and protrusions of a predetermined shape are formed on the second molding surface. Therefore, a hemispherical molded product can be easily removed from the mold when injection molding the molded product with protrusions of a predetermined shape formed on an inner surface thereof.

The present application claims priority under 35 U.S.C. 119 and 35 U.S.C. 365 to Korean Patent Application No. 2005-84136 (filed on Sep. 9, 2005), which is hereby incorporated by reference in its entirety.

### BACKGROUND OF THE INVENTION

1. Field of Invention

The present invention relates to a mold for injection molding, and more particularly, to a mold for injection molding capable of manufacturing a hemispherical molded product with protrusions of a predetermined shape formed on an inner surface thereof.

2. Description of the Prior Art

Generally, a mold for injection molding, which is provided therein with a molding space corresponding to an external shape of a product to be molded, is configured by incorporating a plurality of unit molds that can be disassembled from each other so as to remove a molded product formed in the molding space to the outside.

Meanwhile, in a case of a molded product with a complex external shape, there is also a method in which the molded product or a part of the unit molds is enabled to rotate during a process of separating the incorporated unit molds in order to easily remove the molded product.

However, while easily used to manufacture a molded product such as a helical gear, the aforementioned method cannot be applied to the molded product which has a concavo-convex portion of various shapes on an internal or external surface thereof.

### SUMMARY OF THE INVENTION

Accordingly, the present invention is conceived to solve the aforementioned problems in the prior art. An object of the present invention is to provide a mold for injection molding which makes it possible to easily remove a hemispherical molded product from the mold when injection molding of the hemispherical product with protrusions of a predetermined shape formed on an inner surface thereof.

According to an aspect of the present invention for achieving the object, there is provided a mold for injection molding comprising a first mold having a concave molding surface, and a second mold arranged to be spaced from the first mold at a predetermined distance in order for a cavity to be formed between the molding surface and the second mold. The second mold includes a plurality of unit molds which can be coupled with and disassembled from each other. The molding surface is formed thereon with protrusions having a predetermined shape.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a perspective view showing a mold for injection molding according to the present invention;

FIG. 2 is a perspective view showing a state where a second mold of the mold for injection molding of FIG. 1 is disassembled; and

FIGS. 3 to 5 are views showing a process of removing the second mold from a molded product when manufacturing the molded product using the mold for injection molding according to the present invention.

### DETAILED DESCRIPTION OF THE PREFERRED EMBODIMENT

Hereinafter, a preferred embodiment according to the present invention will be described in detail with reference to the accompanying drawings.

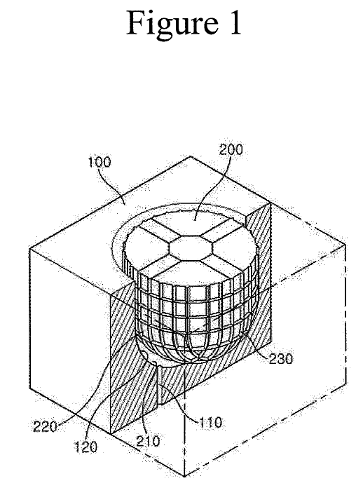

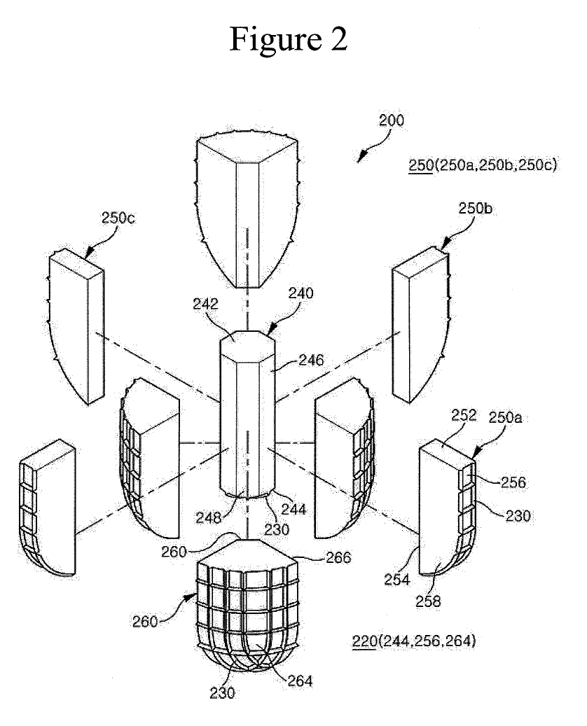

FIG. 1 is a perspective view showing a mold for injection molding according to the present invention, and FIG. 2 is a perspective view showing a state where a second mold of the mold for injection molding of FIG. 1 is disassembled.

As shown in the drawings, the mold for injection molding according to the present invention comprises a first mold 100 and a second mold 200.

The first mold 100 is provided with a gate 110 for feeding a molten material, and a first molding surface 120 communicating with the gate 110 is concavely formed on the top surface of the first mold 100. In addition, a second molding surface 220 is formed on an outer wall surface of the second mold 200. The first and second molds 100 and 200 are arranged to be spaced by a certain distance from each other so that a predetermined cavity 210 is formed between the first and second molding surfaces 120 and 220. The second molding surface 220 is provided with a plurality of protrusions 230 formed in a lattice shape.

The second mold 200 includes a plurality of unit molds 240, 250 and 260 that can be coupled with and disassembled from each other. This is to remove the second mold 200 without damaging the molded product.

In more detail on the second mold, the second mold 200 is configured so that nine unit molds which are classified into three kinds of shapes are coupled to each other to be formed into a cylindrical shape with a hemispheric lower part.

The first unit mold 240, which is a single component, is positioned in the center of the second mold 200. The first unit mold 240 has a top surface 242 formed in a regular octagonal shape and a bottom surface 244 convexly formed to partially define the second molding surface 220. The bottom surface 244 is formed with a part of the protrusions 230. It is described in the present embodiment that the shape of the top surface of the first unit mold 240 is described as the regular octagon, but the shape is not limited thereto. For example, the top surface may have a polygonal shape including an octagon, a hexagon or a regular hexagon.

The second unit molds 250, the number of which is four, are arranged radially from the first unit mold 240 and coupled thereto to be equi-angularly spaced from each other. In other words, an angle between the adjacent second unit molds 250a and 250b is 90 degrees and an angle between the opposite second unit molds 250b and 250c is 180 degrees. The top surface 252 of the second unit mold 250 is formed in a rectangular shape. An inside surface 254 of a shorter side of the rectangle is formed to be brought into contact with a surface 246 of the first unit mold 24. An outside surface 256 positioned opposite to the surface 254 of the shorter side is convexly formed to partially define the second molding surface 220, wherein the convex surface 256 is formed with a part of the protrusions 230.

The third unit molds 260 are coupled between the adjacent second unit molds and are arranged radially from the first unit mold 240. An inside surface 262 of the third unit mold 260 is formed to be brought into contact with a surface 248 of the first unit mold 240. An outside surface 264 positioned opposite to the surface 262 is convexly formed to partially define the second molding surface 220 of the second mold 200, wherein the surface 264 is formed with a part of the protrusions 230. Also, both side surfaces 266 are formed to be brought into contact with adjacent longer side surfaces 258 of the second unit molds 250.

The respective unit molds 240, 250, 260 constructed as above are coupled with each other to be formed into the hemispherical second mold 200, the protrusions 230 are connected with each other to be formed in a lattice shape on the second molding surface 220.

In the meantime, the first unit mold 240 is formed to taper downward such that the second mold 200 is easily coupled and disassembled. It is preferred that the top surface 252 of the second unit mold 250 is formed in an outwardly tapered shape.

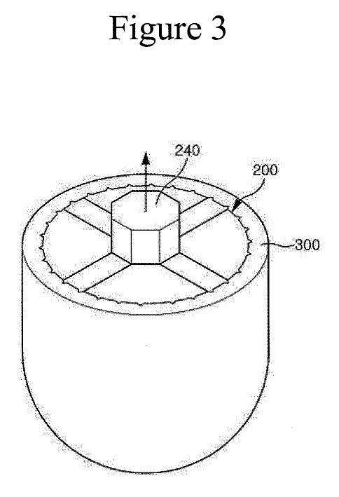

FIGS. 3 to 5 are views showing a process of removing the second mold from a molded product when manufacturing the molded product using the mold for injection molding according to the present invention.

The aforementioned process, which is to remove the second mold without damaging the protrusions formed on the surface of the molded product, will be described with reference to the drawings.

In order to remove the second mold 200 from an initial state where the molded product 300 is attached to the molding surface 220 of the second mold 200, the first unit mold 240 is removed upwardly as shown in FIG. 3. Since the protrusions formed on the bottom surface of the first unit mold 240 are formed in the vertical or nearly vertical direction, the protrusions of the molded product cannot be damaged although the first unit mold 240 is removed upwardly.

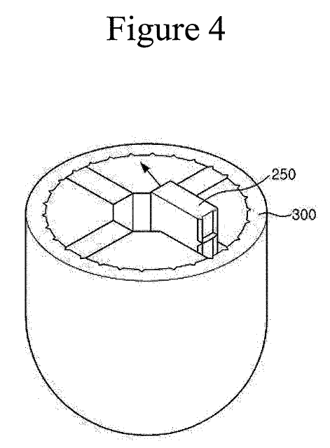

Then, each of the second unit molds 250 is removed in the direction of the arrow in FIG. 4. At this time, the removal direction of the second unit mold 250 should be an oblique direction so that the protrusions 310 of the molded product 300 cannot be damaged.

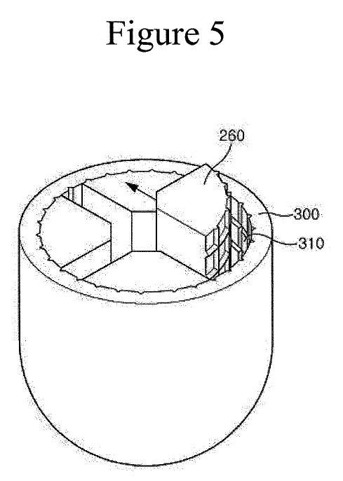

Finally, each of the third unit molds 260 should be removed in the direction of the arrow in FIG. 5. At this time, the third unit mold 260 should be removed in an oblique direction similar with the removing direction of the second unit mold 250 so that the protrusions 310 of the molded product 300 cannot be damaged.

If the second mold 200 is removed according to the aforementioned process, the second mold 200 can be removed without damaging the protrusions 310 of the molded product 300. Thus, it is possible to obtain the molded product of a good quality. Further, the mold can be applied to a plastic injection molding process, or a powder injection molding process that is used to manufacture a metal or ceramics product by mixing a metal or ceramics powder with a binder of an organic material, molding the mixture using the injection molding process, removing the binder, and then sintering the same. Particularly, it is possible to obtain more advantageous effects when the mold is applied to a tungsten powder injection molding process.

According to the mold for injection molding of the present invention, there is an advantageous effect in that the mold can be easily removed without damaging protrusions formed on the inner surface of the molded product by using a plurality of unit molds which can be coupled with and disassembled from each other.

While the construction and operation of the mold for injection molding according to the preferred embodiment of the present invention has been described with reference to the accompanying drawings, it will be apparent that those skilled in the art can make various modifications and changes thereto within the scope of the invention defined by the claims.

What is claimed is:

1. A mold for injection molding comprising:
a first mold having a concave first molding surface; and
a second mold having a convex second molding surface, the second mold being arranged to be spaced from the first mold for a cavity to be defined between the first and second molding surfaces,
wherein the second mold includes a plurality of unit molds coupled with and disassembled from each other, and protrusions of a predetermined shape are formed on the second molding surface.

2. The mold as claimed in claim 1, wherein each of the first and second molding surfaces includes a hemispherical shape.

3. The mold as claimed in claim 2, wherein the mold is applied to a tungsten injection molding process.

4. The mold as claimed in claim 2, wherein the second mold comprises a pillar-shaped first unit mold provided in the center of the second mold, a plurality of second unit molds radially extending from the first unit mold with a certain width and equi-angularly arranged, and third unit molds provided between the adjacent second unit molds.

5. The mold as claimed in claim 1, wherein the protrusions are formed on the second molding surface in a lattice shape.

6. The mold as claimed in claim 5, wherein the mold is applied to a tungsten injection molding process.

7. The mold as claimed in claim 5, wherein the second mold comprises a pillar-shaped first unit mold provided in the center of the second mold, a plurality of second unit molds radially extending from the first unit mold with a certain width and equi-angularly arranged, and third unit molds provided between the adjacent second unit molds.

8. The mold as claimed in claim 1, wherein the mold is applied to a tungsten injection molding process.

9. The mold as claimed in claim 1, wherein the second mold comprises a pillar-shaped first unit mold provided in the center of the second mold, a plurality of second unit molds radially extending from the first unit mold with a certain width and equi-angularly arranged, and third unit molds provided between the adjacent second unit molds.
